(19) United States
(12) Patent Application Publication
(10) Pub. No.: US 2006/0074714 A1
(43) Pub. Date: Apr. 6, 2006

(54) Workflow tracking based on profiles

(75) Inventors: Imran Aziz, Seattle, WA (US); Joel David West, Seattle, WA (US)

Correspondence Address: SENNIGER POWERS, ONE METROPOLITAN SQUARE, 16TH FLOOR, ST. LOUIS, MO, 63102, US

(73) Assignee: Microsoft Corporation, Redmond, WA (US)

(21) Appl. No.: 11/141,418

(22) Filed: May 31, 2005

Related U.S. Application Data
(60) Provisional application No. 60/615,549, filed on Oct. 1, 2004.

(51) Int. Cl. G06Q 10/00

(52) U.S. Cl. 705/2

(57) ABSTRACT

Monitoring an instance of a workflow based on tracking profiles associated therewith. The workflow generates events which are captured by an event filter according to the tracking profiles. Users create the tracking profiles to specify event types of interest to the users. The event filter receives the events from the workflow and filters the received events based on the event types specified in the tracking profiles. The tracking infrastructure allows users to customize the type and quantity of status information to be tracked from the workflow.

### CROSS-REFERENCE TO RELATED APPLICATION

This application claims the benefit of U.S. provisional patent application No. 60/615,549 filed Oct. 1, 2004.

### BACKGROUND

Existing systems model business processes with high-level workflows. A host executes an instance of the workflow and, during execution, events transpire within a particular workflow instance. Typical systems for capturing workflow events are tightly coupled to the workflow instance and are not capable of customization by an end user. In these systems, event capture tools must be built on top of the system executing the workflow. Further, existing systems typically lack a mechanism for capturing workflow events at different degrees of granularity. For example, a user of some of the existing systems cannot modify tracking preferences after deployment of the workflow.

### SUMMARY

Embodiments of the invention enable a mechanism through which workflow applications may provide a rich user experience. In particular, embodiments of the invention enable users to specify workflow events to be captured by the workflow system. Users specify the workflow events to be tracked in a tracking profile associated with each workflow. Each tracking profile may be modified at runtime. In this manner, workflow applications present users with a current state and history of a particular workflow instance. For example, for a workflow describing document routing, the invention is operable to show who has reviewed a document previously and how many review cycles the document has gone through.

One or more tracking providers may subscribe to a stream of tracking events. The invention is agnostic to the storage format for persisting the tracking events. For example, the tracking events may be persisted to either a file data source or a database by multiple tracking providers consuming the same stream. In this example, a single tracking profile specifies which workflow events to capture.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary workflow containing tasks and control flow composite activities.

FIG. 2 is an exemplary block diagram illustrating the interaction of the tracking framework with an executing workflow schedule instance and tracking providers.

FIG. 3 is an exemplary block diagram illustrating a runtime having an executing workflow and an event filter.

FIG. 4 is an exemplary flow chart illustrating operation of the tracking framework of the invention.

FIG. 5 is a block diagram illustrating one example of a suitable computing system environment in which the invention may be implemented.

FIG. 6 is a screenshot illustrating an exemplary document review workflow.

Appendix A lists an exemplary extensible markup language (XML) schema for a tracking profile.

Appendix B lists exemplary tracking profiles.

Appendix C lists tracking types exposed to the host environment for the host to interact with the tracking system of the invention.

Appendix D lists exemplary code associated with a tracking provider.

Corresponding reference characters indicate corresponding parts throughout the drawings.

### DETAILED DESCRIPTION

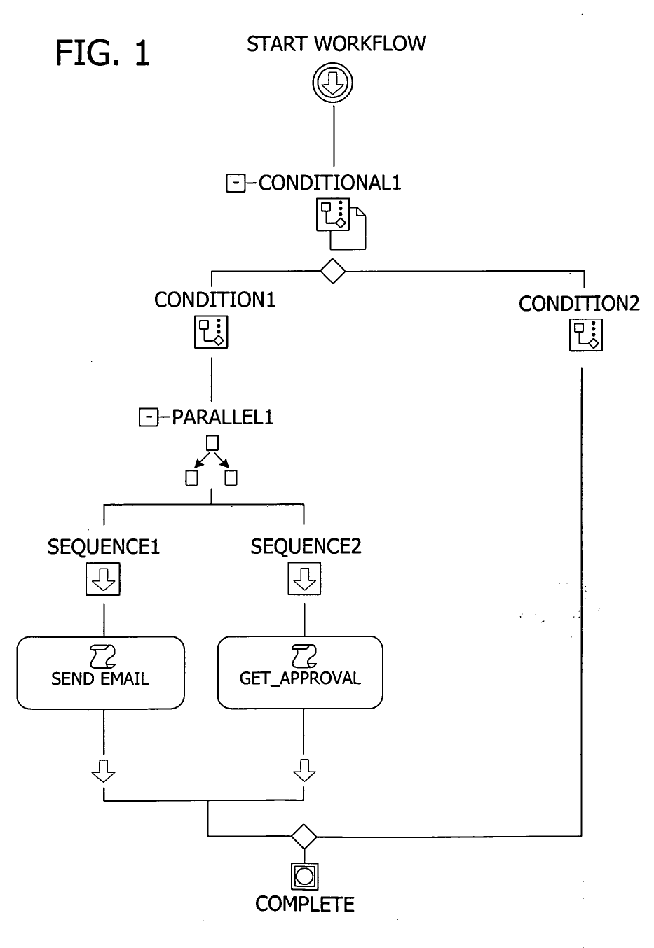

FIG. 1 illustrates an exemplary workflow. Embodiments of the invention are operable with a workflow representing a process such as a business process. Business processes are dependent on ordered tasks, activities, or the like that result in predictable and repeatable outcomes. Including the operating procedures, institutional working knowledge, and information resources of an organization, business processes are designed to satisfy defined business objectives in an efficient and timely manner. In an efficient environment, the functional components of a process can be readily identified, adapted, and deployed to address ever-changing corporate requirements. The workflow is an end user's experience interacting with the tasks in a business process. Tasks are modeled as activities, components, or the like, each representing a unit of work that is performed by a person or machine. In one embodiment, a plurality of activities is presented to a user. The user selects and organizes the activities to create the workflow. The created workflow is executed to model the business process. An example of a workflow is shown in FIG. 1. FIG. 1 is an exemplary workflow containing tasks and control flow composite activities.

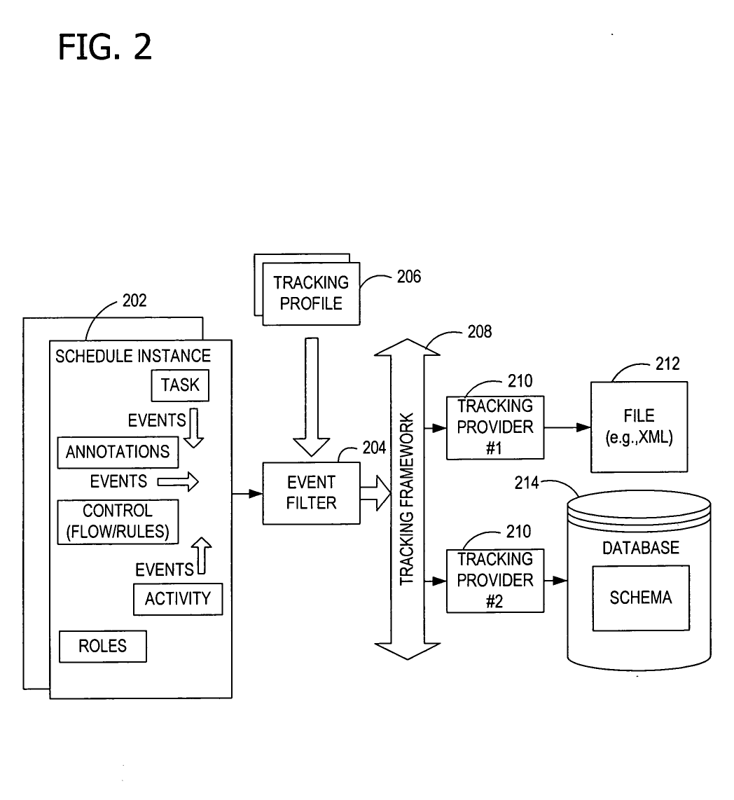

In one embodiment, the invention provides a scalable and reliable tracking infrastructure such as shown in FIG. 2 to enable application programs to track workflow-related information in a consistent, reliable and flexible manner. FIG. 2 is an exemplary block diagram illustrating the interaction of the tracking framework 208 with an executing workflow schedule instance 202 and tracking providers 210, such as tracking provider #1 and tracking provider #2. Tracking may refer to the historical collection of events associated with schedules, tasks, activities, principals, workflow (imperative and declarative) data and associated data contained within a given workflow instance. In particular, the illustrated embodiment of the invention includes an interface (e.g., the tracking framework 208) for the applications to query for workflow information and for users to obtain workflow information (e.g., workflow status) in a uniform manner across various hosting environments. Aspects of the invention enable users and applications to track workflow information (e.g., workflow state and history) in a consistent manner for both executing workflows and archived workflows. These aspects also provide a mechanism to track workflow data agnostic of the data store. For example, while there is a well-defined schema for tracking events, the data store controls the schema for the persisted data. In the example of FIG. 2, tracking provider #1 stores the data in a file 212 while tracking provider #2 stores the data in a particular schema in a database 214.

An event tracking infrastructure of the invention reduces the amount of coupling between a consumer of tracking data and the engine producing the data from the workflow, reduces the size of tracking components in memory, reduces the impact of tracking components on persistence and ‘rehydration,’ and executes inline with engine execution logic (e.g., no asynchronous calls). While tracking providers 210 have the ability to request enormous amounts of data via tracking profiles such as tracking profile 206, the actual extraction work is handled by the runtime engine executing the workflow which makes it possible to tune this process to optimize performance of the executing workflow.

As shown in FIG. 2, the workflow tracking system provides for both propagation and filtering of workflow events. Workflow or tracking events are emitted by the runtime as a result of schedule execution (e.g., execution of a workflow or task) and are passed through an event filter 204 which is associated with a schedule instance 202. The event filter 204 is, or is part of or associated with, the tracking framework 208 which uses tracking profiles (e.g., tracking profile 206) to determine at a high level the event types to subscribe to. The tracking framework 208 also performs additional filtering and data extraction as events are emitted by the runtime during execution of the workflow. Some of the tracking events are lightweight and carry only information that enables the event filter 204 to identify which tracking provider 210 is currently subscribed to the event. However, events sent to the tracking providers 210 may include any amount of data. Message payloads and schedule data may be associated with tracking events by the tracking framework 208 based on the associated tracking profile 206. The tracking framework 208 of FIG. 2 is responsible for filtering and collecting events and data and delivering those events and data to the tracking service that requested them. Tracking profiles 206 allow administrators and business users to configure the type and amount of data that they wish to track without making code changes either to the workflows or to host runtime components. Unlike previous systems, it is not necessary in the present invention to edit code associated with the runtime engine to determine what data is tracked.

The tracking provider 210 receives the set of filtered events and controls how they are persisted. The tracking provider 210 has the ability to specify which tracking events it wants to listen to through the associated tracking profiles 206. Tracking providers 210 are able to subscribe to all tracking events across all deployed schedules.

Tracking Data

In general, event data includes data that describes any aspect of the schedule, workflow, task, or activity within the workflow. Event data includes events and data. A large amount of different types of events and data are available for tracking. The following exemplary information may be tracked within a workflow:
a) Activation, completion and interrupt behavior for each schedule, task and activity,
b) Enter/exit of transactional and scope boundaries,
c) Control and rule evaluation,
d) Workflow owners, observers, and participants,
e) Message sends and receives.

A task, such as shown in FIG. 2, is a child instance executed with call semantics. Workflow instances or schedule instances such as schedule instance 202 have their own event filters 204, tracking channels and tracking profile instances. For example, if there are five tasks in schedule instance 202, there will be six filter instances. This allows each filter 204 to execute independently and allows tasks to establish their own profiles 206 if desired. The following exemplary information may be tracked for a task:
a) Initiating principal,
b) Input parameters,
c) Target principals,
d) Actions performed on a task (e.g., reassign, forward, cancel),
e) Task response,
f) Output parameters,
g) Associated annotations,
h) Containing schedule and type information

Although described in the context of the exemplary workflow and task information listed above, aspects of the invention are operable with any information describing or relating to a workflow or schedule instance 202. For example, a workflow designer may annotate a schedule with key performance indicators for tracking important stages within a workflow (e.g., queried across aggregated workflow instances), end user descriptors such as comments and descriptions that the workflow designer may want the end user to view as workflow tasks are initiated, and design descriptors for specifying a particular path through a workflow. For example, the successful flow of execution through a particular workflow might be execution tasks T1, T3 and T5. This is particularly useful to guide users to enable them to navigate through complicated workflows.

In one embodiment, there are different types or classes of events exposed for tracking. Each type of event has its own semantics. In an alternative embodiment, all events are of one event type. The tracking providers 210 may group events of differing types into a single structure for processing, or maintain the separation of events of differing event types to process such events separately.

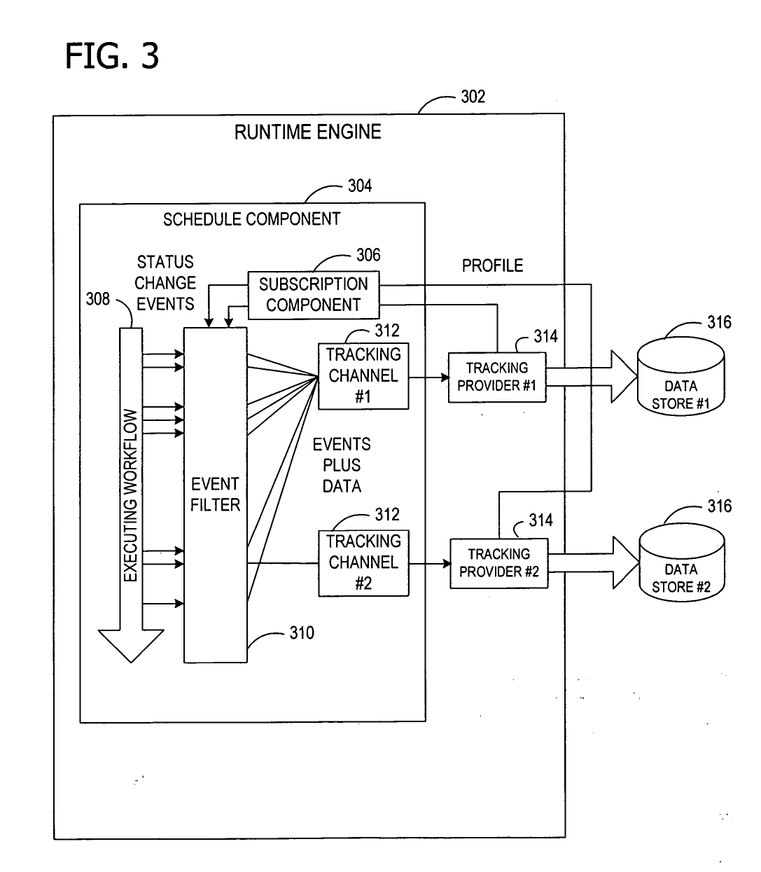

In one embodiment, event types include activity status change events, workflow instance events, and user events. Activity status change events are shown in FIG. 3. Activity status change events and instance-based events are updated as the workflow executes. Activity status change events describe the status of activities executing in the workflow and correspond to state transitions that activities move through as they are executed by the runtime. Activity status change events monitor where a particular workflow instance is at any given point in time, determine what path a workflow instance took, determine common paths (e.g., what activity path is taken by most instances of a given workflow type), and collect data. Exemplary activity status change events include ‘initialized,’ ‘executing,’ ‘faulting,’ ‘compensating,’ ‘cancelling,’ and ‘closed.’ In an alternative embodiment, other activity status change events include ‘suspended’ and ‘completed.’ Tracking profiles 206 limit the activity status change events received by activity type (e.g., specify a base type and track all activities that are derived from that type regardless of inheritance depth), by status event, and by activity member values that are set at design time (e.g., specify that only activities with an identifier equal to “Code1” be tracked).

Instance events describe the status of the executing workflow (e.g., the workflow executing in FIG. 3) and correspond to events that occur for the instance as opposed to a single activity. These events include, for example, events such as ‘suspended,’ ‘dehydrated,’ and ‘exception.’ Instance events are used to monitor which instances are actively in memory and which are on disk, to monitor idle instances, to monitor exceptions that are thrown by activities and caught by the runtime, and to monitor instances that are terminated. A tracking profile 206 may specify instance events and activity status events to track to determine which activities are blocked. Exemplary instance events include ‘created,’ ‘shutdown,’ ‘completed,’ ‘idle,’ ‘suspended,’ ‘resume,’ ‘persisted,’ ‘dehydrated,’ ‘rehydrated,’ ‘exception,’ ‘terminated,’ ‘aborted,’ and ‘changed.’ Tracking profiles 206 can restrict the instance events they wish to receive by only including those events.

User events are non-runtime events. These events are raised a particular method that can be called both by activity writers and workflow writers. For example, an activity writer may raise a user event to signify that it is in a state that is specific to that activity. A workflow writer might raise a user event to expose that something meaningful to the workflow has occurred. Tracking profiles 206 can restrict the user events they wish to receive by activity type (e.g., specify a base type and track all activities that are derived from that type regardless of inheritance depth), by argument type (e.g., specify a base type and track all events that have arguments that are derived from that type regardless of the inheritance depth), and by activity member values that are set at design time. For example, it is possible to specify that only user events associated with activities having an identifier equal to “Code1” be tracked.

Aspects of the invention provide for tracking event specific data as well as data that is not specific to an event (e.g., a data extract). Extracts are available for activities members, data context members, and activity instance data. Data that falls into the extract category may be explicitly requested using the appropriate extract derived classes. In one embodiment, data extracts may be used whenever an event occurs for an activity (e.g., activity status change events and user events). An exception is thrown any time an extract error occurs (e.g., the data does not exist).

In one embodiment, an activity status change event captured from an executing workflow instance includes only enough information for the tracking framework 208 to associate data with the event before submitting the event and the data to the tracking provider 210. Such a tracking event may have data extracted for it and put into a payload for submission to the tracking provider 210. Alternatively, such a tracking event may not include a payload, but rather include the following exemplary information:
a. ID: An identifier which uniquely identifies the event across schedule instances.
b. Namespace: A namespace represents a grouping of events which can be used to aggregate events across schedule instances.
c. Type: Represents one of the following types of events:
   1. Start: An activity has been successfully started.
   2. Completion: An activity has completed successfully.
   3. Exception: An exception occurred while the activity was being executed.
   4. End: The activity code has been exited.
d. Schedule type: A descriptor which represents the schedule type.
e. Schedule instance ID: A unique ID which the runtime uses to identify the running instance of a schedule (e.g., schedule instance 202).
f. Activity ID: Represents the activity type which is associated with this event.
g. Date/Time: The date/time at which the event was emitted by the runtime.
   Tracking Profiles

Tracking profiles 206 are used by tracking providers 210 to specify the events and data to be received from a runtime engine executing a workflow instance. The profile 206 may be viewed as an abstraction to avoid exposing the internal structure of the runtime engine. Tracking profiles 206 enable users to maintain control over which tracking events are submitted to the tracking provider 210 at runtime and to specify the schedule or message data that should be associated with the tracking event. Data is associated with the tracking events by the tracking framework 208 and propagated to the tracking provider 210.

Each tracking provider 210 that is registered with the hosting environment stores the profiles 206 and may provide a profile 206 for each workflow or schedule type that is run, or may provide a profile 206 to apply to all schedule types registered with the hosting environment. For example, a tracking provider 210 that is doing error tracking may wish to use the same profile 206 for every workflow type while a tracking provider 210 that collects data for end users may wish to use a different profile 206 for each type.

Tracking profiles 206 are represented to the runtime with a TrackingProfile class. This strongly typed class supports tools that wish to automate the profile creation process. However, the invention is operable with a profile 206 written manually in, for example, extensible markup language (XML) and deserialized to a TrackingProfile instance. In one embodiment, tracking profiles 206 are XML files conforming to a well-defined schema and corresponding to a workflow model. Appendix A lists an exemplary extensible markup language (XML) schema for a tracking profile 206 while Appendix B lists exemplary tracking profiles. Tracking profiles 206 define inclusion and exclusion sections for tracking events. A tracking profile 206 may also provide instructions to the runtime engine on how to associate data with tracking events. Data can be associated using activity properties or deferred to the code defined within the schedule (e.g., the executing workflow). If no data association is provided then just a default level of data is tracked. Tracking profiles 206 may specify control over tracking events using an Include Field and an Exclude Field. The Include Field specifies which events should be tracked at runtime and the Exclude field specifies which events should be excluded from tracking at runtime.

Tracking profiles 206 are documents that have the potential to occupy a large amount of memory and increase the amount of data to be persisted. Some tracking profiles 206 may be expensive to repeatedly search. For this reason, event filters 204 tracking the runtime do not directly handle or contains references to the actual profile 206 in one embodiment. In one embodiment, tracking profiles 206 are cached by the invention to avoid repeatedly asking the tracking provider 210 for the tracking profile 206 with each created workflow instance. The invention receives an event from a tracking provider 210 as notification of a new or updated version of a profile 206 created by the tracking provider 210. In one embodiment, a ‘profile updated’ event and a ‘profile removed’ event are triggered when a profile 206 has been updated and removed, respectively. Messages sent during these events flow between the tracking provider 210 and the event filter/framework

While tracking profiles 206 may contain tracking directives for all activities in a workflow, information about the following activities may be of particular interest to tracking providers 210: Schedule, Scope, Send, Task, Message, Receive, Handler, Code, Delay, Fault, Conditional, Parallel, Sequence, Composite Activity Group, and While.

In an alternative embodiment, any of the activities in a workflow may also have tracking profiles 206 associated with them which apply across all schedules deployed within a particular host environment. For example, an administrator may deploy a tracking profile 206 for Send and Receive activities which apply across all running schedule instances. Conflict resolution on which tracking profiles 206 should be used for a particular activity may be performed as follows in one embodiment:
a. Tracking profile 206 for parent level activity always overrides a default tracking profile 206 for the child activity. In this manner, a schedule or scope can override the tracking behavior for all contained activities.
b. Tracking profile 206 associated with an activity can always override a specified tracking event within the schedule code.
   In this manner, a system administrator may enable an extra level of tracking or remove detailed tracking altogether for certain schedules due to security or storage requirements while business analysts or end users may be interested in tracking a totally different set of data.

A tracking profile 206 may reference another tracking profile 206. The following exemplary rules apply to resolve conflicts that may occur between inclusion and exclusion sections of the tracking profile:

a. All parent level inclusions override child level exclusions.

b. All parent level exclusions override child level inclusions. Below is an example of a tracking profile 206 referencing another tracking profile 206.

<TrackingProfile>

<Header name=”mytrackingprofile” description=”Message
tracking” />
<Include Profile name=”mymessagelevelprofiles” />
<Exclude Profile name=”mymessagelevelprofiles” />

</TrackingProfile>

Tracking Levels

Tracking levels enable a profile writer to specify certain default levels of tracking without specifying detailed inclusion and exclusion directives. The following are exemplary default levels:

a. Engine: All runtime events and associated data. This is the most detailed level of tracking available.

b. Activity: All runtime events associated with activities will be captured.

c. Task: All runtime events associated with tasks, including all task properties will be captured.

d. None: Turns tracking off completely.

An example of a simple tracking profile 206 which uses levels is shown below:

<TrackingProfile>

<Include>

<Scope>

<ID>Z</ID>

<Level>Task</Level>
</Scope>

</Include>

</TrackingProfile>

In an alternative embodiment, developers building schedules and tasks may wish to instrument their code with explicit tracking events that they wish the runtime to emit. A schedule developer can emit tracking events by using the AddTrackingEvent method within the Engine.Runtime class as shown below.
Engine.Tracking.Event myEvent=new Engine.Tracking.Event;
myEvent.setEvent( . . . );
engine.AddTrackingEvent( . . . , myEvent);

In an alternative embodiment, the functionality of tracking levels is implemented by a feature allowing the profile authors to specify that all activities derived from a base type should be matched by a trackpoint (e.g., a marker used to identify events to capture, as shown in Appendix A). This feature allows profile authors to write their own levels.

Event Filters

Referring next to FIG. 3, an exemplary block diagram illustrates a runtime engine 302 having an executing workflow 308 and an event filter 310. A schedule component 304 creates a workflow instance which generates a plurality of events during execution of the workflow instance (e.g., executing workflow 308). In the embodiment of FIG. 3, the event filter 310, tracking filter, or other filter component is internal to the runtime engine 302. There is one event filter 310 per workflow or schedule instance. The event filter 310 acts as an abstraction layer for tracking providers 314 (e.g., tracking provider #1 and tracking provider #2) to prevent access by the tracking providers 314 to the internal structures of the runtime engine 302. Tracking providers 314 and their channels 312 (e.g., tracking channel #1 and tracking channel #2) are written by hosts or third parties. In one embodiment, each schedule instance has a tracking channel instance for each tracking provider 314 registered in the provider environment, unless the provider 314 does not provide a profile for the instance's schedule type. While the embodiment of FIG. 3 illustrates the tracking providers 314 executing in the same process space as the runtime engine 302, the tracking providers 314 may be separate from the runtime engine 302 in other embodiments such as shown in FIG. 2.

FIG. 3 includes a subscription component 306 for identifying one or more tracking providers 314 associated with the created workflow instance, obtaining a tracking profile for the created workflow instance from each of the identified tracking providers 314, and subscribing each of the tracking providers 314 to event types in the tracking profile corresponding to the tracking provider 314 based on the obtained tracking profile. In the embodiment of FIG. 3, the subscription component 306 is part of the runtime 302.

The component of the runtime engine 302 responsible for handling raw events is the event filter 310 or other tracking filter. In the embodiment of FIG. 3, the event filter 310 is part of the runtime engine 302. Filters are internal to the engine 302 and interface directly with the engine's components to process events. Unlike previous systems, the runtime engine 302 does not write data directly to a data store itself. Writing to a data store is accomplished by the tracking providers 314. Filters may also be indirectly called by user code to process custom tracking points. In general, the invention includes means for filtering the plurality of events as a function of the tracking profile. Hardware, software, firmware, computer-executable components, and/or computer-executable instructions constitute means for filtering the plurality of events as a function of the tracking profile.

In one embodiment, the event filter 310 is a computer-executable component having computer-executable instructions for receiving an event corresponding to one of the subscribed event types during execution of the workflow instance, extracting event data from the received event, identifying one or more of the tracking providers 314 subscribed to the event type corresponding to the received event, and sending the extracted event data to the identified tracking providers 314.

Appendix C lists tracking types exposed to the host environment for the host to interact with the tracking system of the invention. In a particular embodiment, event filters 310 interact with the tracking profiles in layers of indirection as shown in the following example, which references some of the exemplary classes and types identified in Appendix C:
a. A method associated with the event filter 310 obtains instances of tracking channels 312 when the instance is created.
b. The event filter 310 asks a ProfileManager for a TrackingProfile object for each TrackingService type registered in the system. The profile manager is an internal runtime engine component that optimizes the retrieval of profiles and their searches.
c. The ProfileManager checks if a copy of the profile is already in memory (e.g., a cache). If so, then the most recent version of the profile is returned.
d. If the ProfileManager does not have a copy of the requested profile in memory, it will request it from the TrackingService using a GetProfile method.
e. The event filter 310 creates the appropriate event subscriptions according to the tracking profiles.
f. The event filter 310 receives events from the engine based on subscriptions.
g. The event filter 310 filters events and associated data based on the tracking profiles.
h. The event filter 310 calls a TrackingChannel.Send method to push requested data and block until the channel 312 returns.

Tracking providers 314 receive data using tracking channels 312. Whenever a new schedule instance is created (e.g., workflow schedule or task schedule) or when a schedule instance is rehydrated, each provider 314 registered in the provider environment is asked for a tracking channel 312 via a TrackingService.GetTrackingChannel method. The provider 314 is passed a TrackingParameters object that holds information such as the identifier of the new instance, type, and call stack information.

Tracking providers 314 in the example of FIG. 3 are responsible for moving data events pushed to them to their corresponding data stores 316 such as data store #1 and data store #2. To register tracking providers 314, hosts create an instance of each provider type that they support and hand them to the provider environment. This means that it is up to the host to determine which tracking providers 314 are enabled. Some hosts may decide that only a predetermined set of tracking providers 314 will run. Other hosts may expose registering providers 314 to third party developers to enable those developers to integrate tracking data into their own systems. While the number of tracking providers 314 that may be registered is not fixed, there is a performance threshold beyond which adding additional providers 314 becomes too expensive to meet a given set of performance goals due to the work that each provider 314 performs. A host should consider the impact of the providers 314 it decides to register on the performance of the engine.

Tracking providers 314 have responsibilities including delivering data to a data source via a tracking channel 312. The tracking provider 314 determines what data source is used and what the schema that holds the data looks like. The runtime engine 302 has no hard requirement on what the data source is or how the schema is defined. Another responsibility is to deliver data to its data source in the manner most appropriate for the host/client/query scenario. For example, a highly scalable host implementation where tracking is used for reporting or after the fact investigation is best suited by a provider 314 that dumps serialized data to an intermediate table for asynchronous processing by a separate process or remote machine. Conversely, in other scenarios, the tracking provider 314 may need to write data to its data store 316 in a format that can be immediately queried. Generally, such scenarios are not tracking fine-grained events (they are not collecting large amounts of data) because the normalization of event data by a provider 314 has more impact on the performance of the runtime engine 302 than a tracking provider 314 that writes data.

Appendix D lists exemplary code associated with a tracking provider.

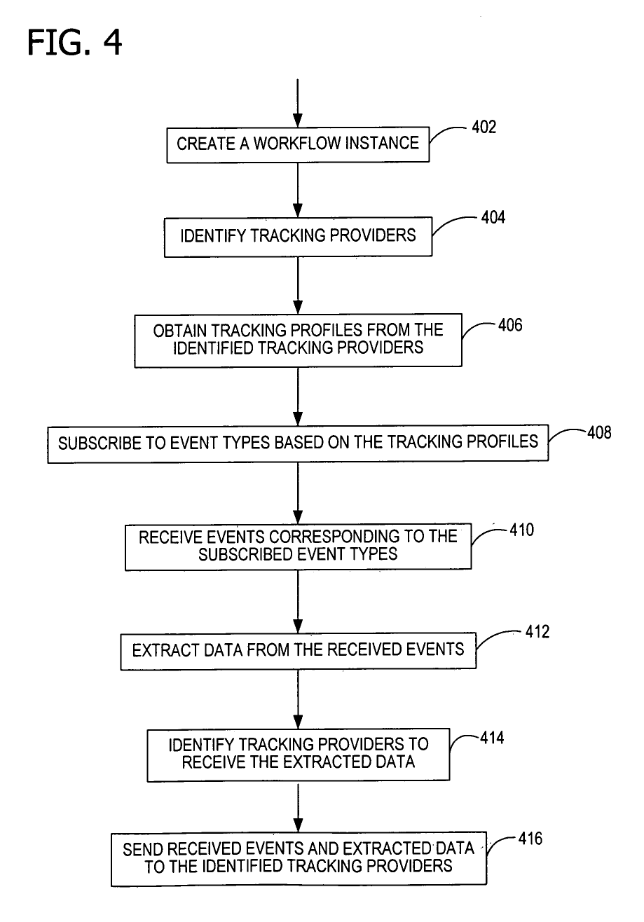

Referring next to FIG. 4, an exemplary flow chart illustrates operation of the tracking framework for monitoring a workflow. Filters access data for both filtering and extraction via the properties and methods specified by the profiles. The method illustrated in FIG. 4 includes creating a workflow instance at 402. The method creates an event filter by loading tracking providers and their profiles for the instance type. The method identifies one or more tracking providers associated with the created workflow instance at 404 and obtains a tracking profile for the created workflow instance from each of the identified tracking providers at 406. The method includes asking each tracking provider for a profile associated with the created instance. When a profile is requested, a schedule type of the instance is passed to the tracking provider. The tracking provider may define profiles on a per schedule type basis in this manner. However, a provider may use a single profile for all schedule types.

The tracking profile identifies one or more event types to the identified tracking providers and the identified event types correspond to at least one of the plurality of events to be tracked. The method further includes subscribing, based on the obtained tracking profile, each of the tracking providers to the event types in the tracking profile corresponding to the tracking provider at 408. Events are produced on a subscription basis. Fewer subscriptions mean reduced overhead for the engine. The filter adds the subscriptions that are required to get the data that is requested by a tracking profile. This provides the flexibility of being able to change the data that is tracked without recompiling.

During execution of the workflow instance, events are received at 410. The method extracts data (e.g., messaging data) from one or more of the plurality of events corresponding to one of the subscribed event types at 412. The method identifies one or more of the tracking providers subscribed to the event type corresponding to the received event at 414 and sends the data extracted from each of the events having the subscribed event types to the identified tracking providers at 416. The event data passed to the tracking providers includes data about the activity that triggered the event and the data requested by the tracking profile. The tracking providers consume the tracking events and control how tracking events are persisted to a data store for querying. The identified tracking providers store the extracted data in one or more of the following: a relational database, a file, and volatile memory.

Communication between the event filter and the tracking providers is done in one embodiment via a synchronous method call (e.g., TrackingChannel.Send in the TrackingChannel class described in Appendix C). The event filter blocks execution while calling into providers. In the event that TrackingChannel.Send throws an exception (e.g., the tracking provider generates an exception), the TrackingListener logs the exception and continue processing. The TrackingListener continues to make calls to the TrackingChannel that threw the exception. In an alternative embodiment, aspects of the invention treat the exception from the tracking provider similar to an exception from within a workflow instance or an activity.

Embodiments of the invention allow a user to edit the tracking profile during execution of the workflow. The event filter is notified of the updated tracking profile and loads the updated tracking profile during execution of the workflow. In this manner, the tracking profile may be dynamically modified during execution of the workflow instance.

In one embodiment, one or more computer-readable media have computer-executable instructions for performing the method shown in FIG. 4.

In a specific embodiment, a flow of internal profile requests is as follows:
a. A new schedule instance is created.
b. A ProfileManager internal to a workflow runtime engine is asked for the most recent profile for the schedule type and tracking provider type.
c. If the ProfileManager has profiles for the schedule type and tracking provider type it will return a wrapper around the most recent profile version.
d. If the ProfileManager does not have any profiles for the schedule type and tracking provider type it will call a function such as TrackingService.GetProfile(Type scheduleTypeld).
e. Each tracking provider determines what profile is appropriate for the supplied schedule type, retrieves that profile from its own data store and returns it.
   Transactional Consistency

In one embodiment, the invention provides for explicit transactional consistency. The invention provides tracking channels with a mechanism for participating in persistence point transactions to achieve data consistency with the engine. Tracking providers generally do not wish to store records related to events, that faulted and were rolled back in the executing workflow. As such, tracking data is committed to the tracking data store in the same transaction as other work for the current scope. However, the tracking provider developer or host may wish to record event data regardless of its scope's success (e.g., ask for notifications of uncommitted work). Such tracking providers may do their own batching and may also write data to their data stores independent of persistence points. These tracking providers also account for the possible collision of duplicate data (e.g., the same event “occurring” twice due to transaction retry or resumption of an instance from dehydration after a process crash). The tracking providers mark data corresponding to events in a faulted transaction.

Exemplary Operating Environment

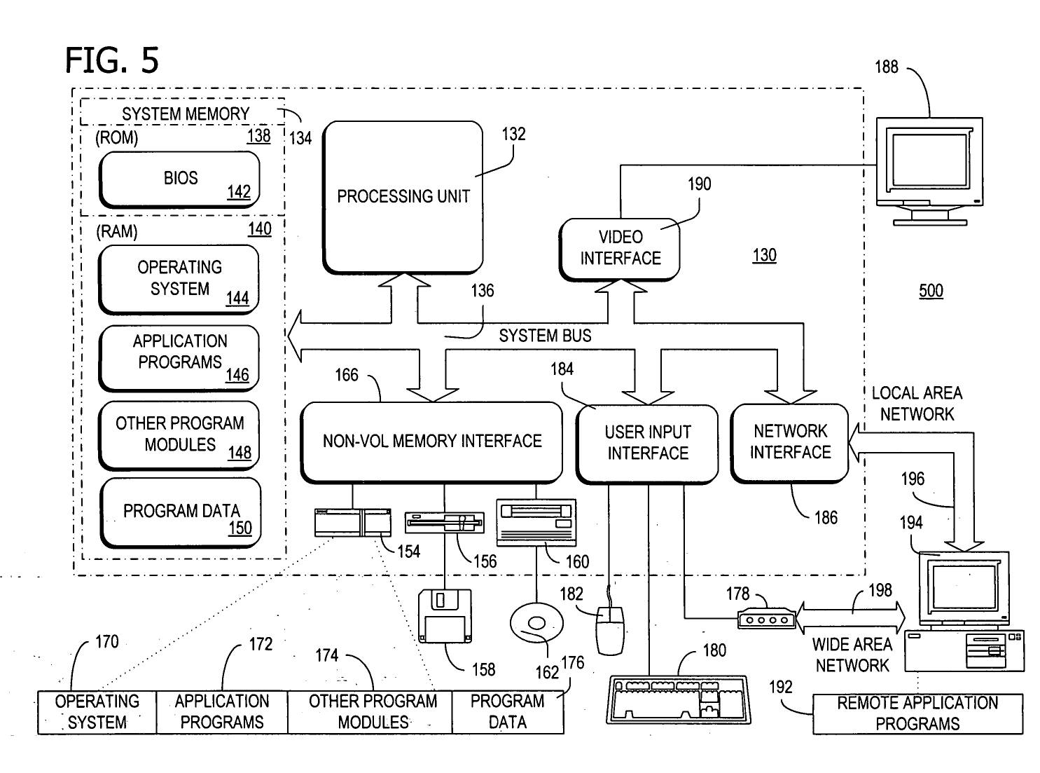

FIG. 5 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 5 illustrates operating system 144, application programs 146, other program modules 148, and program data 150.

The computer 130 may also include other removable/non-removable, volatile/nonvolatile computer storage media. For example, FIG. 5 illustrates a hard disk drive 154 that reads from or writes to non-removable, nonvolatile magnetic media. FIG. 5 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 5, provide storage of computer readable instructions, data structures, program modules and other data for the computer 130. In FIG. 5, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 5 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 5 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in the figures to implement the invention.

### EXAMPLES

The following examples further illustrate the invention. In a document review scenario, an information worker (e.g., Jenny) within a manufacturing company wants to review a new project proposal that she has just created. The proposal includes a document and a spreadsheet that she has uploaded to a shared document library. Company policies requires that all new project proposals go through certain prescreening steps before they are considered for funding: a) Submit proposal for peer review, c) Get Approval from manager and department head, c) Submit proposal to greenhouse team for review.

The information worker selects a “New project proposal” workflow template of the invention and associates the relevant project documents with it. The workflow template guides the information worker to the first step within the process and prompts for certain required parameters such a subject (e.g., the title of the review request), a message (e.g., the description that you want to communicate to reviewers), the list of users you want to receive feedback from on the specification, reviewers who should be notified about the review, a due date for feedback, and a reminder date for obtaining feedback.

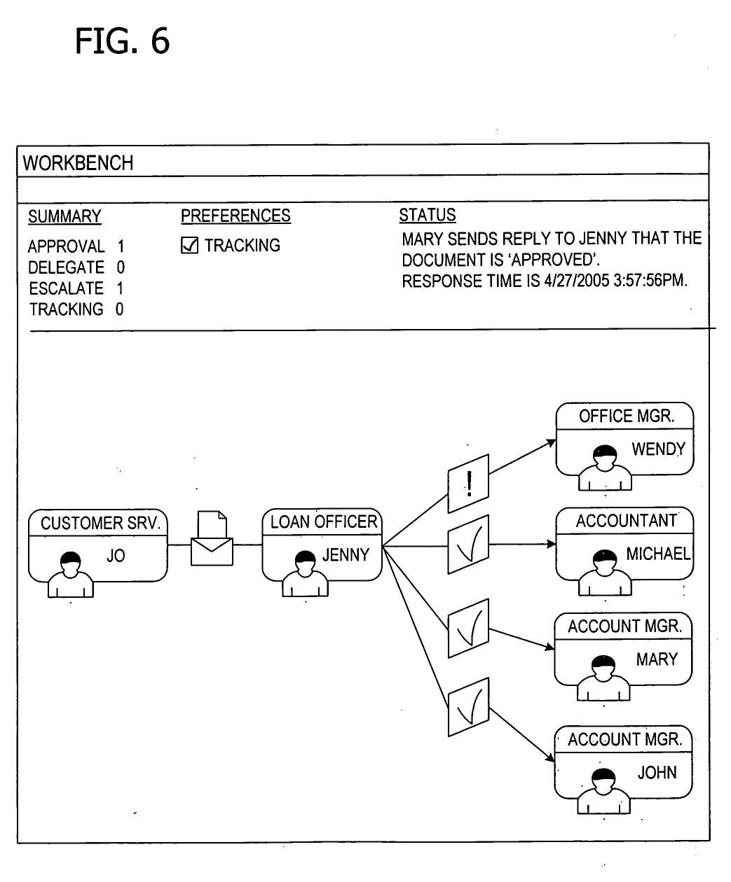

After the information worker fills out the parameters, she will be notified that the peer feedback loop has been started. She is encouraged to incorporate feedback into the project documents before proceeding to the next step within the process, which is submission of the proposal to management. Subsequently, the information worker wishes to see how her project proposal is tracking. She opens a workflow view associated within the project files and sees a snapshot the workflow state including history as shown in FIG. 6. FIG. 6 is a screenshot illustrating an exemplary document review workflow.

The information worker views the state of the workflow and realizes that even though she had not explicitly assigned a task to Wendy, a task was automatically assigned to Wendy due to lack of response from Michael. Jenny examines the feedback she has received from her peers and incorporates in into her project proposal. She can now move forward on the next steps within the workflow which she is automatically guided towards.

In this scenario, information flowing through the workflow needs to be tracked and queried upon workflow parameters submitted by the information worker, user and role assignments for scheduled tasks, user task responses and status, control flow constructs such as parallel and serial task scheduling, and rules which affect task behavior (such as auto escalation based on lack of response from Michael).

In a loan application scenario, Joseph wants to model a loan application workflow. A simple loan application process that Joseph wants to model includes the following steps: a) Review loan application, b) Verify applicant's credit, c) Verify applicant's references, d) Submit application for approval if both credit and references check out. To model this workflow, Jason opens up a workflow designer and uses the palette of tasks that Sanjeev has already developed. He builds a schedule which composes these tasks in a particular order and specific rules which govern their runtime behavior. Joseph would like to specify a default tracking profile for the loan application workflow such that the following events are tracked and capable of being queried at runtime for each instance of the workflow: initiating user, target user, reassigned to, payloads associated with the workflow (documents, URLs, etc.), task responses by users, and key performance indicators (e.g., verify candidate stage). In addition, he would like to instrument the schedule such that all transition between steps (e.g., review application to verify candidate stage) result in tracking events being fired at runtime.

In an administrator scenario, Mandy is an administrator of a shared site used by loan officers to get access to loan application templates and processes. Before deploying a new loan application process and associating it with a loan applications document library, she performs the following operations:
a. Enables detailed tracking for all documents flowing to and from the loan application process,
b. Enables detailed tracking for all message payload flowing to and from the loan application process,
c. Enables tracking of all state changes and exceptions per instance of the process,
d. Enables detailed tracking for all user interaction with the loan application process.

Mandy asks the box administrator to archive the tracking information and performs the following operations at the site level to track the new loan application process:
a. Enables the default tracking profile that Joseph had associated with the loan application process,
b. Enables tracking only on workflow tasks and user responses
   This scenario illustrates how within a departmental scenario, an administrator controls the level of tracking per deployed workflow process type.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

### APPENDIX A

An exemplary extensible markup language (XML) schema for a tracking profile is shown below.

<?xml version=“1.0” encoding=“utf-8”?>
<xs:schema id=“TrackingProfile” targetNamespace=“//TrackingProfile”
elementFormDefault=“qualified” xmlns=“//TrackingProfile”
xmlns:xs=“http://www.w3.org/2001/XMLSchema”>

<xs:element name=“TrackingProfile” type=“TrackingProfileType” />
<xs:complexType name=“TrackingProfileType”>

<xs:sequence>

<xs:element name=“TrackPoints”
type=“TrackPointListType”

minOccurs=“1” maxOccurs=“1” />

</xs:sequence>
<xs:attribute name=“version” type=“VersionType” />

</xs:complexType>
<xs:complexType name=“TrackPointListType”>

<xs:sequence>

<xs:choice minOccurs=“1” maxOccurs=“unbounded”>

<xs:element name=“ActivityTrackPoint”

type=“ActivityTrackPointType” />

<xs:element name=“UserTrackPoint”

type=“UserTrackPointType” />

<xs:element name=“InstanceTrackPoint”

type=“InstanceTrackPointType” />

</xs:choice>

</xs:sequence>

</xs:complexType>
<xs:complexType name=“ActivityTrackPointType”>

<xs:sequence>

<xs:element name=“MatchingLocations” minOccurs=“1”

maxOccurs=“1” type=“IncludeActivityLocationListType” />

<xs:element name=“ExcludedLocations” minOccurs=“0”

maxOccurs=“1” type=“ExcludeActivityLocationListType” />

<xs:element name=“Annotations”
type=“AnnotationListType”

minOccurs=“0” maxOccurs=“1” />

<xs:element name=“Extracts” type=“ExtractListType”

minOccurs=“0” maxOccurs=“1” />

</xs:sequence>

</xs:complexType>
<xs:complexType name=“IncludeActivityLocationListType”>

<xs:sequence>

<xs:element name=“ActivityLocation”

type=“ActivityLocationType” minOccurs=“1”
maxOccurs=“unbounded” />

</xs:sequence>

</xs:complexType>
<xs:complexType name=“ExcludeActivityLocationListType”>

<xs:sequence>

<xs:element name=“ActivityLocation”

type=“ActivityLocationType” minOccurs=“0”
maxOccurs=“unbounded” />

</xs:sequence>

</xs:complexType>
<xs:complexType name=“ActivityLocationType”>

<xs:sequence>

<xs:element name=“Activity” type=“Type” minOccurs=“1”

maxOccurs=“1” />

<xs:element name=“StatusEvents”
type=“StatusEventListType”

minOccurs=“1” maxOccurs=“1” />

<xs:element name=“Conditions” type=“ConditionListType”

minOccurs=“0” maxOccurs=“1” />

</xs:sequence>

</xs:complexType>
<xs:complexType name=“UserTrackPointType”>

<xs:sequence>

<xs:element name=“MatchingLocations”

type=“IncludeUserLocationListType” minOccurs=“1” maxOccurs=“1” />

<xs:element name=“ExcludedLocations”

type=“ExcludeUserLocationListType” minOccurs=“0” maxOccurs=“1” />

<xs:element name=“Annotations”
type=“AnnotationListType”

minOccurs=“0” maxOccurs=“1” />

<xs:element name=“Extracts” type=“ExtractListType”

minOccurs=“0” maxOccurs=“1” />

</xs:sequence>

</xs:complexType>
<xs:complexType name=“IncludeUserLocationListType”>

<xs:sequence>

<xs:element name=“UserLocation”
type=“UserLocationType”

minOccurs=“1” maxOccurs=“unbounded” />

</xs:sequence>

</xs:complexType>
<xs:complexType name=“ExcludeUserLocationListType”>

<xs:sequence>

<xs:element name=“UserLocation”
type=“UserLocationType”

minOccurs=“0” maxOccurs=“unbounded” />

</xs:sequence>

</xs:complexType>
<xs:complexType name=“UserLocationType”>

<xs:sequence>

<xs:element name=“Activity” type=“Type” minOccurs=“1”

maxOccurs=“1” />

<xs:element name=“Argument” type=“Type”
minOccurs=“1”

maxOccurs=“1” />

<xs:element name=“Conditions” type=“ConditionListType”

minOccurs=“0” maxOccurs=“1” />

</xs:sequence>

</xs:complexType>
<xs:complexType name=“InstanceTrackPointType”>

<xs:sequence>

<xs:element name=“MatchingLocation”

type=“InstanceLocationMatchType” minOccurs=“1” maxOccurs=“1” />

<xs:element name=“Annotations”
type=“AnnotationListType”

minOccurs=“0” maxOccurs=“1” />

</xs:sequence>

</xs:complexType>
<xs:complexType name=“InstanceLocationMatchType”>

<xs:sequence>

<xs:element name=“InstanceLocation”

type=“InstanceLocationType” minOccurs=“1” maxOccurs=“1” />

</xs:sequence>

</xs:complexType>
<xs:complexType name=“InstanceLocationType”>

<xs:sequence>

<xs:element name=“InstanceStatusEvents”

type=“InstanceStatusEventListType” minOccurs=“1” maxOccurs=“1” />

</xs:sequence>

</xs:complexType>
<xs:complexType name=“Type”>

<xs:sequence>

<xs:choice>

<xs:element name=“TypeName”
type=“NonNullString” />
<xs:element name=“Type” type=“NonNullString” />

</xs:choice>
<xs:element name=“MatchDerivedTypes”
type=“xs:boolean”

minOccurs=“1” maxOccurs=“1” default=“false” />

</xs:sequence>

</xs:complexType>
<xs:complexType name=“AnnotationListType”>

<xs:sequence>

<xs:element name=“Annotation” type=“xs:string”

minOccurs=“0” maxOccurs=“unbounded” />

</xs:sequence>

</xs:complexType>
<xs:complexType name=“ConditionListType”>

<xs:sequence>

<xs:element name=“ActivityCondition”

type=“ActivityConditionType” minOccurs=“0”
maxOccurs=“unbounded” />

</xs:sequence>

</xs:complexType>
<xs:complexType name=“ActivityConditionType”>

<xs:sequence minOccurs=“1” maxOccurs=“1”>

<xs:element name=“Operator” type=“OperatorType”

minOccurs=“1” maxOccurs=“1” />

<xs:element name=“Member” type=“NonNullString”

minOccurs=“1” maxOccurs=“1” />

<xs:element name=“Value” type=“xs:string”
minOccurs=“0”

maxOccurs=“1” nillable=“true” />

</xs:sequence>

</xs:complexType>
<xs:simpleType name=“OperatorType”>

<xs:restriction base=“xs:string”>

<xs:enumeration value=“Equals” />
<xs:enumeration value=“NotEquals” />

</xs:restriction>

</xs:simpleType>
<xs:complexType name=“StatusEventListType”>

<xs:sequence>

<xs:element name=“Status” type=“StatusType”
minOccurs=“1”

maxOccurs=“8” />

</xs:sequence>

</xs:complexType>
<xs:simpleType name=“StatusType”>

<xs:restriction base=“xs:string”>

<xs:enumeration value=“Initialized” />
<xs:enumeration value=“Executing” />
<xs:enumeration value=“Faulting” />
<xs:enumeration value=“Compensating” />
<xs:enumeration value=“Cancelling” />
<xs:enumeration value=“Suspended” />
<xs:enumeration value=“Completed” />
<xs:enumeration value=“Closed” />

</xs:restriction>

</xs:simpleType>
<xs:complexType name=“InstanceStatusEventListType”>

<xs:sequence>

<xs:element name=“InstanceStatus”
type=“InstanceStatusType”

minOccurs=“1” maxOccurs=“13” />

</xs:sequence>

</xs:complexType>
<xs:simpleType name=“InstanceStatusType”>

<xs:restriction base=“xs:string”>

<xs:enumeration value=“Created” />
<xs:enumeration value=“Shutdown” />
<xs:enumeration value=“Completed” />
<xs:enumeration value=“Idle” />
<xs:enumeration value=“Suspended” />
<xs:enumeration value=“Resumed” />
<xs:enumeration value=“Persisted” />
<xs:enumeration value=“Dehydrated” />
<xs:enumeration value=“Rehydrated” />
<xs:enumeration value=“Exception” />
<xs:enumeration value=“Terminated” />
<xs:enumeration value=“Aborted” />
<xs:enumeration value=“Changed” />

</xs:restriction>

</xs:simpleType>
<xs:complexType name=“ExtractListType”>

<xs:choice minOccurs=“0” maxOccurs=“unbounded”>

<xs:element name=“ActivityExtract”

type=“ActivityExtractType” />

<xs:element name=“DataContextExtract”

type=“DataContextExtractType” />

</xs:choice>

</xs:complexType>
<xs:complexType name=“ActivityExtractType”>

<xs:sequence minOccurs=“1” maxOccurs=“1”>

<xs:element name=“Member” type=“NonNullString”

minOccurs=“1” maxOccurs=“1” />

<xs:element name=“Annotations”
type=“AnnotationListType”

minOccurs=“0” maxOccurs=“unbounded” />

</xs:sequence>

</xs:complexType>
<xs:complexType name=“DataContextExtractType”>

<xs:sequence minOccurs=“1” maxOccurs=“1”>

<xs:element name=“Member” type=“xs:string”
minOccurs=“1”

maxOccurs=“1” />

<xs:element name=“Annotations”
type=“AnnotationListType”

minOccurs=“0” maxOccurs=“unbounded” />

</xs:sequence>

</xs:complexType>
<xs:simpleType name=“VersionType”>

<xs:restriction base=“xs:string”>

<xs:pattern value=“(\hat{ }[0-2147483646]\.[0-2147483646]\.[0-

2147483646]\.[0-2147483646]$)|(\hat{ }[0-2147483646]\.[0-2147483646]\.[0-
2147483646]$)|(\hat{ }[0-2147483646]\.[0-2147483646]$)” />

</xs:restriction>

</xs:simpleType>
<xs:simpleType name=“NonNullString”>

<xs:restriction base=“xs:string”>

<xs:minLength value=“1” />

</xs:restriction>

</xs:simpleType>

</xs:schema>

### APPENDIX B

Exemplary profiles are shown below.

/***********************************************************************
*
* Simple Include:
* A simple profile to track executing and closed events for all activities
* Useful for tracing execution progress
*
* ***********************************************************************/
TrackingProfile profile = new TrackingProfile( );
TrackingProfile p2 = null;
string xml = null;
profile.Version = new Version( “1.0.0” );
ActivityTrackPoint atp = new ActivityTrackPoint( );
ActivityLocation location = new ActivityLocation( typeof( Activity ) );
location.MatchDerivedTypes = true;
foreach ( Status s in Enum.GetValues( typeof( Status ) ) )
{

location.Events.Add( s );

}
atp.MatchingLocations.Add( location );
profile.ActivityTrackPoints.Add( atp );
/***********************************************************************
*
* Simple Include:
* A profile to track executing and closed events for all OCS based activities
*
* ***********************************************************************/
profile = new TrackingProfile( );
profile.Version = new Version( “1.0.0” );
atp = new ActivityTrackPoint( );
location = new ActivityLocation( typeof( MethodInvoke ) );
location.MatchDerivedTypes = true;
location.Events.Add( Status.Executing );
location.Events.Add( Status.Closed );
atp.MatchingLocations.Add( location );
location = new ActivityLocation( typeof( EventSink ) );
location.MatchDerivedTypes = true;
location.Events.Add( Status.Executing );
location.Events.Add( Status.Closed );
atp.MatchingLocations.Add( location );
profile.ActivityTrackPoints.Add( atp );
/***********************************************************************
*
* Simple Include/Exclude:
* A profile to track all activities except for Code and Replicator
*
* ***********************************************************************/
profile = new TrackingProfile( );
profile.Version = new Version( “1.0.0” );
atp = new ActivityTrackPoint( );
location = new ActivityLocation( typeof( Activity ) );
location.MatchDerivedTypes = true;
location.Events.Add( Status.Executing );
location.Events.Add( Status.Closed );
atp.MatchingLocations.Add( location );
location = new ActivityLocation( typeof( Code ) );
location.Events.Add( Status.Executing );
location.Events.Add( Status.Closed );
atp.ExcludedLocations.Add( location );
location = new ActivityLocation( typeof( Replicator ) );
location.Events.Add( Status.Executing );
location.Events.Add( Status.Closed );
atp.ExcludedLocations.Add( location );
profile.ActivityTrackPoints.Add( atp );
/***********************************************************************
*
* Simple User Event Include:
* A simple profile to track user code events with a string argument for all activities
* Useful for hosting environment that want to record environment specific data
*
* ***********************************************************************/
profile = new TrackingProfile( );
profile.Version = new Version( “1.0.0” );
UserTrackPoint ctp = new UserTrackPoint( );
UserLocation uloc = new UserLocation( );
uloc.ActivityType = typeof( Activity );
uloc.MatchDerivedActivityTypes = true;
uloc.ArgumentType = typeof( string );
uloc.MatchDerivedArgumentTypes = false;
ctp.MatchingLocations.Add( uloc );
profile.UserTrackPoints.Add( ctp );
/***********************************************************************
*
* Instance Include:
* A profile to track the terminated event for an instance
*
*
* ***********************************************************************/
profile = new TrackingProfile( );
profile.Version = new Version( “1.1” );
profile.InstanceTrackPoints.Add( new InstanceTrackPoint( ) );
profile.InstanceTrackPoints[0].MatchingLocation = new InstanceLocation( );
profile.InstanceTrackPoints[0].MatchingLocation.Events.Add( InstanceStatus.Terminated );
/***********************************************************************
*
* Include a specific activity:
* Use a Condition to constraint the activities matched by this trackpoint
*
*
* ***********************************************************************/
profile = new TrackingProfile( );
profile.Version = new Version( “1.1” );
ActivityLocation loc = new ActivityLocation( typeof( While ) );
ActivityCondition condition = new ActivityCondition( );
condition.Member = “ID”;
condition.Value = “While1”;
condition.Operator = ComparisonOperator.Equals;
loc.Conditions.Add( condition );
loc.Events.Add( Status.Closed );
atp = new ActivityTrackPoint( );
atp.MatchingLocations.Add( loc );
profile.ActivityTrackPoints.Add( atp );
/***********************************************************************
*
* Extract a DataContext data member and an Activity member at a specific event:
* Use a Condition to constraint the activities matched by this trackpoint
* Use a DataContextExtract to access the desired data member
*
*
* ***********************************************************************/
profile = new TrackingProfile( );
profile.Version = new Version( “1.1” );
loc = new ActivityLocation( typeof( While ) );
condition = new ActivityCondition( );
condition.Member = “ID”;
condition.Value = “While1”;
condition.Operator = ComparisonOperator.Equals;
loc.Conditions.Add( condition );
loc.Events.Add( Status.Closed );
atp = new ActivityTrackPoint( );
atp.MatchingLocations.Add( loc );
atp.Extracts.Add( new DataContextExtract( “_counter” ) );
atp.Extracts.Add( new ActivityExtract( “QualifiedID” ) );
profile.ActivityTrackPoints.Add( atp );
/***********************************************************************
*
* Activity, User and Instance TrackPoints
*
* ***********************************************************************/
profile = new TrackingProfile( );
profile.Version = new Version( “1.0.0” );
atp = new ActivityTrackPoint( );
location = new ActivityLocation( typeof( Activity ) );
location.MatchDerivedTypes = true;
location.Events.Add( Status.Executing );
location.Events.Add( Status.Closed );
atp.MatchingLocations.Add( location );
location = new ActivityLocation( typeof( Code ) );
location.Events.Add( Status.Executing );
location.Events.Add( Status.Closed );
atp.ExcludedLocations.Add( location );
location = new ActivityLocation( typeof( Replicator ) );
location.Events.Add( Status.Executing );
location.Events.Add( Status.Closed );
atp.ExcludedLocations.Add( location );
profile.ActivityTrackPoints.Add( atp );
ctp = new UserTrackPoint( );
uloc = new UserLocation( );
uloc.ActivityType = typeof( Activity );
uloc.MatchDerivedActivityTypes = true;
uloc.ArgumentType = typeof( string );
uloc.MatchDerivedArgumentTypes = false;
ctp.MatchingLocations.Add( uloc );
profile.UserTrackPoints.Add( ctp );
profile.InstanceTrackPoints.Add( new InstanceTrackPoint( ) );
profile.InstanceTrackPoints[0].MatchingLocation = new InstanceLocation( );
profile.InstanceTrackPoints[0].MatchingLocation.Events.Add( InstanceStatus.Terminated );

### APPENDIX C

The following tracking types are exposed to the host environment for the host to interact with the tracking system.

Tracking Provider

Every tracking provider that is registered with the invention derives from TrackingService or the like. TrackingService objects will be registered with the ProviderEnvironment. This class acts as a factory for producing TrackingChannel objects. When a new schedule instance is created all TrackingService based objects registered in the ProviderEnvironment will be obtained and asked to create a new TrackingChannel for the instance.

public abstract class TrackingService
{

public TrackingService ( );
public TrackingChannel GetTrackingChannel( TrackingParameters

parameters );

public string GetProfile( Type scheduleType );
public string GetProfile( Type scheduleType, int profileVersionId );
public event ProfileUpdateEventHandler ProfileUpdate;

}

ProfileUpdateEventHandler

public delegate ProfileUpdateEventHandler(object sender, ProfileUpdateEventArgs e);

ProfileUpdateEventArgs

The ProfileUpdateEventArgs class should be passed when the OnprofileUpdate event is raised by a TrackingService.

public abstract class ProfileUpdateEventArgs

{

public ProfileUpdateEventArgs( );
public ProfileUpdateEventArgs( string profile );
public string Profile{ get; set; }

}

TrackingChannel

The TrackingChannel class is used to receive tracking data from an instance. There is one TrackingChannel derived object for each TrackingService for each schedule instance.

public abstract class TrackingChannel
{

public TrackingChannel( );
public TrackingChannel( TrackingParameters parameters );
public abstract void Send( TrackingRecord record );

}

TrackingParameters

The TrackingParameters class is used to convey information about the schedule instance to TrackingChannels. An instance of this class will be passed to TrackingService.GetTrackingChannel when a new schedule instance is created.

public class TrackingParameters
{

public Guid InstanceId{ get; set; }
public Guid ScheduleTypeId{ get; set; }

}

TrackingRecord

TrackingRecord is the type that is passed from the filter to the providers. It wraps a single event that has been requested by the tracking profile and contains only the data requested in the profile for the event in question.

public class TrackingRecord
{

public string QualifiedID { get; set; }
public Type Type { get; set; }
public Status Status { get; set; }
public DateTime EventTime { get; set; }
public Dictionary<string, TrackingDataItem> Body { get; }

}

TrackingDataItem

TrackingDataItem is a container for a single piece of extracted data and its associated annotations.

public class TrackingDataItem
{

public IList<string> Annotations{ get; set; }
public object Data{ get; set; }

}

The host environment does not need to have knowledge of the following types to interact with the tracking infrastructure.

TrackingListenerFactory

The TrackingListenerFactory provides an abstraction for creating a Filter object. This type takes care of constructing a Filter and supplying it with all of the data that the Filter needs include providers and their tracking profiles. All instances of Filter objects should be created using a method on this class.

public class TrackingListenerFactory
{

public TrackingListenerFactory( );
pubic Filter GetFilter( Guid instanceId, Type scheduleType );

}

TrackingListener

The TrackingListener class manages event subscriptions. There is one TrackingListener per schedule instance. Each TrackingListener instances manages N TrackingChannels (there is a 1 to many relationship of TrackingListeners to TrackingChannels).

public class TrackingListener
{

public TrackingListener( ISchedule sked, IScheduleExecutor
skedExec,

ChannelWrapper[] channels);

public void SubscriptionEventHandler( IExecutor sender,
object subArg);

}

ProfileManager

Implements a profile cache. Hands out Profile objects that perform lookups and other work using the cache of profiles.

public class ProfileManager
{

public ProfileManager( ProviderEnvironment env );
public Profile GetProfile( Type scheduleType, Type

TrackingServiceType);

public Profile GetProfile( Type scheduleType, Type

TrackingServiceType, int versionId);
}

TrackingProfile

public class TrackingProfile
{

public Profile ( string profile );
public int VersionId{ get; set; }
public Type ScheduleType{ get; set; }
public Type TrackingServiceType{ get; set; }
public bool SubscriptionNeeded( IActivity activity );
public void ExtractData( IActivity activity, Dictionary<string,

TrackingDataItem> data );
}

ChannelWrapper

Lightweight wrapper to associate channels to provider types and profiles.

public class ChannelWrapper
{

public ChannelWrapper( );
public Type TrackingServiceType{ get; set; }
public TrackingChannel TrackingChannel{ get; set; }
public Profile Profile{ get; set; }

}

### APPENDIX D

Exemplary code associated with a tracking provider that writes activity events to a console window is shown below.

using System;
using System.Collections;
using System.Collections.Specialized;
using System.Text;
using System.Xml;
using System.IO;
using System.Workflow.Runtime;
using System.Workflow.ComponentModel;
using System.Workflow.Runtime.Hosting;
namespace TrackingServiceSample
{

public class ConsoleTrackingService : TrackingService
{

public override string GetProfile( Type scheduleTypeId )
{

return GetProfile( );

}
public override string GetProfile( Type scheduleTypeId, int versionId )
{

return GetProfile( );

}
public override string GetProfile( Guid scheduleInstanceId )
{

// Does not support reloading/instance profiles
return null;

}
public override bool ReloadProfile( Type scheduleType, Guid scheduleInstanceId, out string

profile )

{

// Does not support reloading/instance profiles
profile = null;
return false;

}
public override TrackingChannel GetTrackingChannel( TrackingParameters parameters )
{

return new ConsoleTrackingChannel( parameters, this );

}
public void Track( Guid instanceId, TrackingRecord record )
{

Console.WriteLine( FormatRecord( instanceId, record ) );

}
private TrackingProfile GetProfile( )
{

//
// Add a TrackPoint to cover all activity status events
TrackingProfile profile = new TrackingProfile( );
profile.Version = new Version( “1.0” );
ActivityTrackPoint atp = new ActivityTrackPoint( );
ActivityLocation location = new ActivityLocation( typeof( Activity ) );
location.MatchDerivedTypes = true;
foreach ( Status s in Enum.GetValues( typeof( Status ) ) )
{

location.Events.Add( s );

}
atp.MatchingLocations.Add( location );
profile.ActivityTrackPoints.Add( atp );
//
// Add a TrackPoint to cover all instance events
InstanceTrackPoint ltp = new InstanceTrackPoint( );
ltp.MatchingLocation = new InstanceLocation( );
foreach ( InstanceStatus i in Enum.GetValues( typeof( InstanceStatus ) ) )

ltp.MatchingLocation.Events.Add( i );

profile.InstanceTrackPoints.Add( ltp );
//
// Add a TrackPoint to cover all user events
UserTrackPoint utp = new UserTrackPoint( );
UserLocation uLoc = new UserLocation( );
uLoc.ActivityType = typeof( Activity );
uLoc.MatchDerivedActivityTypes = true;
uLoc.ArgumentType = typeof( object );
uLoc.MatchDerivedArgumentTypes = true;
utp.MatchingLocations.Add( uLoc );
profile.UserTrackPoints.Add( utp );
return profile;

}
protected virtual string FormatRecord( Guid instanceId, TrackingRecord record )
{

StringBuilder sb = new StringBuilder( );
sb.Append( “\r\n\r\n” );
sb.Append( “*******************************************************\r\n” );
sb.Append( “TrackingRecord\r\n” );
sb.Append( “*******************************************************\r\n\r\n”

);

FormatItem( “Instance ID”, instanceId.ToString( ), ref sb );
FormatItem( “Event Time”, record.EventDateTime.ToString( ), ref sb );
FormatItem( “Qualified ID”, record.QualifiedId, ref sb );
FormatItem( “Type”, record.Type, ref sb );
FormatItem( “Status”, record.Status, ref sb );
foreach ( TrackingDataItem item in record.Body )
{

FormatItem( item.FieldName, item.Data, ref sb );
foreach ( string a in item.Annotations )

FormatItem( “\tAnnotation”, a, ref sb );

}
return sb.ToString( );

}
protected virtual void FormatItem( string key, object val, ref StringBuilder sb )
{

sb.Append( key + “: ” + val + “\r\n” );

}

}
public class ConsoleTrackingChannel : TrackingChannel
{

private ConsoleTrackingService _service = null;
private TrackingParameters _parameters = null;
public ConsoleTrackingChannel( TrackingParameters parameters, ConsoleTrackingService

service )

{

_service = service;
_parameters = parameters;

}
public override void Send( TrackingRecord record )
{

_service.Track( _parameters.InstanceId, record );

}
public override void WorkflowChange( ICollection workflowChanges, IRootActivity

rootActivity, DateTime changeDateTime )

{

// Skip workflow changes

}

}

}

What is claimed is:

1. A method of tracking the execution of a workflow, said method comprising:
creating a workflow instance, said workflow instance generating a plurality of events during execution of the workflow instance;
identifying one or more tracking providers associated with the workflow instance;
obtaining a tracking profile for the workflow instance from each of the identified tracking providers, said tracking profile identifying one or more event types to the identified tracking providers, said identified event types corresponding to at least one of the plurality of events to be tracked;
subscribing, based on the obtained tracking profile, each of the tracking providers to the event types in the tracking profile corresponding to the tracking provider;
receiving, during execution of the workflow instance, data extracted from one or more of the plurality of events corresponding to one of the subscribed event types;
identifying one or more of the tracking providers subscribed to the event type corresponding to the received event; and
sending the data extracted from each of the events having the subscribed event types to the identified tracking providers.

2. The method of claim 1, further comprising receiving the tracking profile from one of the tracking providers.

3. The method of claim 1, further comprising storing, by the identified tracking providers, the extracted data in one or more of the following: a relational database, a file, and volatile memory.

4. The method of claim 1, wherein the extracted data comprises messaging data.

5. The method of claim 1, further comprising providing the tracking profile to a user for modification.

6. The method of claim 1, further comprising dynamically modifying the tracking profile by:
obtaining an updated tracking profile from one of the tracking providers while the workflow instance is executing; and
subscribing to event types based on the updated tracking profile while the workflow instance is executing.

7. The method of claim 1, wherein receiving the event corresponding to one of the subscribed event types comprises receiving an event associated with a committed transaction in the workflow.

8. The method of claim 1, further comprising storing the tracking profile for use with another workflow instance.

9. The method of claim 1, further comprising:
receiving data extracted from a plurality of events over a time interval during execution of the workflow instance; and
sending the received data extracted from the plurality of events to the identified tracking providers as a group.

10. The method of claim 1, further comprising one or more computer-readable media having computer-executable instructions for performing the method of claim 1.

11. A computerized system for monitoring an executing workflow, said computerized system comprising:
a tracking profile for identifying one or more of a plurality of events to be tracked, said plurality of events being generated by an executing workflow instance;
an event filter for generating a tracking stream based on the tracking profile, said tracking stream comprising the identified one or more of the plurality of events; and
a tracking provider for receiving the tracking stream from the event filter.

12. The computerized system of claim 11, wherein the tracking provider provides the tracking profile.

13. The computerized system of claim 11, wherein the events comprise user-defined events.

14. The computerized system of claim 11, further comprising a plurality of tracking providers and tracking profiles associated therewith.

15. The computerized system of claim 11, further comprising a data structure representing the tracking profile, said data structure having an include field for specifying events to be tracked and an exclude field for specifying events to not track.

16. The computerized system of claim 11, wherein the plurality of events each have a status associated therewith, and wherein said status comprises one or more of the following: executing, canceling, closed, completed, compensated, created, suspended, resumed, terminated, persisted, dehydrated, re-hydrated, and exceptions.

17. The computerized system of claim 11, wherein the plurality of events comprises one or more of the following: user events, instance-based events, and activity status events.

18. The computerized system of claim 11, further comprising means for filtering the plurality of events as a function of the tracking profile.

19. One or more computer-readable media having computer-executable components for monitoring a workflow, said components comprising:
a schedule component for creating a workflow instance, said created workflow instance generating a plurality of events during execution of the workflow instance;
a subscription component for:
identifying one or more tracking providers associated with the created workflow instance;
obtaining a tracking profile for the created workflow instance from each of the identified tracking providers, said tracking profile identifying one or more event types;
subscribing, based on the obtained tracking profile, each of the tracking providers to the event types in the tracking profile corresponding to the tracking provider; and
a filter component for:
receiving, during execution of the workflow instance, an event corresponding to one of the subscribed event types;
extracting event data from the received event;
identifying one or more of the tracking providers subscribed to the event type corresponding to the received event; and
sending the extracted event data to the identified tracking providers.

20. The computer-readable media of claim 19, wherein a single tracking profile is associated with a plurality of the tracking providers to direct storage of event data.
